(19) United States
(12) Patent Application Publication
(10) Pub. No.: US 2016/0333928 A1
(43) Pub. Date: Nov. 17, 2016

(54) MACHINE TOOL WITH AN IMPROVED COVERING FOR THE TRANSLATIONAL MOVEMENT GUIDE

(71) Applicant: Spinner Werkzeugmaschinenfabrik GmbH, Sauerlach (DE)

(72) Inventor: Ulrich SPINNER, Sauerlach (DE)

(73) Assignee: Spinner Werkzeugmaschinenfabrik GmbH, Sauerlach (DE)

(21) Appl. No.: 15/110,319

(22) PCT Filed: Jan. 7, 2015
(86) PCT No.: PCT/EP2015/050132

§ 371 Date: Jul. 7, 2016

(30) Foreign Application Priority Data
Jan. 7, 2014 (DE) 10 2014 200 064.5

(51) Int. Cl. F16C 29/08; B23Q 11/08

(52) U.S. Cl. CPC F16C 29/08; B23Q 11/08; F16C 2322/39

(57) ABSTRACT

The invention relates to a machine tool (10) for the machining, and preferably stock removal, of a workpiece by means of a tool, comprising at least one translational movement device (18) which displaces the tool and workpiece relative to one another along a movement axis (X), said movement device (18) comprising a base structure (22), a movement part (20) that can be moved along the movement axis relative to the base structure (22), a linear guide device (24) that extends along the movement axis (X) and guides the movement of the movement part (20), and a movement drive that drives the movement of said movement part (20). The linear guide device (24) and the movement drive are covered, so as to protect them from external influences such as chipping accumulation and/or lubricant and/or coolant sprays, by a cover (34) which is designed to be separate from the movement part (20). The invention is characterised in that said cover (34) extends in the movement axis (X) direction at least substantially across the full length of the linear guide device (24) and, during operation and specifically during a proper displacement operation of said movement part (20), is secured to the base structure (22) so as not to move relative thereto.

The present application relates to a machine tool for the preferably machining a work piece by using a tool with at least one translational motion device for positioning of tool and work piece relatively to each other along a motion axis, wherein the movement device demonstrates a basic structure, a portable motion part in longitudinal direction to the movement axis relatively to the base structure, a linear guide device leading to the movement of the motion part, located along the movement axis, and a motion part for motion drive driving to the movement, wherein the linear guide device and the motion drive are covered to be protected against external influences, such as large chip volumes and/or lubricants and/or coolant spills, through a separately formed cover panel from the motion part.

These types of machine tools are known in general, for example as metal cutting machine tools, so in the form of universal drill and/or milling machines. Such machine tools have usually multiple motion devices with translational movement axis running in directions linear independent from each other from where one of them normally runs along the work piece being processed and is movable translational. The machine tools can also have rotational movement devices with rotational movement axis, which usually also serve the motion of the work piece.

The movement devices with horizontal—or more generally not vertical—translational movement axis are subject of high dirt contamination on the machine tools because the chips and/or coolants and/or lubricants may occur there because of gravity effect coming from the point of processing.

To prevent that dirt from the processing place comes to the linear guide device and damages it in the further operation, the linear guide device and the motion driving unit of a translational moving device are usually covered with a cover panel. Usually such cover panel is designed in the state of the art in the form of a box with elements with telescopic variable lengths. This means, the cover panel is segmented in the direction of the respective motion axis, wherein a final segment of the link box on one of the moving parts of the motion axis nearest to the longitudinal end of the cover panel is connected to the common axial movement with the moving part, while usually a final segment is fixed relatively to the motion axis of the base structure at the end of the opposite length. Between these final segments are more intermediate segments, which are axially relatively movable to each other of the aforementioned ones. Thereby, a segment placed from outside closer to the moving part encompasses the segment that in each case is placed axially to the immediately neighbouring moving part in the direction of the motion axis away from the moving part. The resulting gaps between axial adjacent segments are sealed by known seal arrangements against ingress of dirt.

This results in multiple circumstances that require improvement:

From one side, through the both fixed link segments connected with moving part on the one hand, and basic structure, on the other hand, with the specified dimensions, maximum possible axial movement path of the moving part is restricted to translational motion device.

On the other hand, for each movement device, two cover panels are usually necessary, because usually one distance of each axial longitudinal end of the moving part to this nearest longitudinal end of the base structure must be covered.

The restriction of the axial movement path of the moving part enables to be limited through shortening of the selected segment length.

However, it can succeed only conditionally, because, with fixed length of the moving distance to be covered, with a reduction in the length of segment, an increase of the number of segments of the covered link box is caused. Since links box design overlaps each segment being axial adjacent to the most distanced segment of the moving part, so the telescopic extendable and retractable link box with increasing number of segments will be in its dimensions increasingly building room demanding, orthogonally to the motion axis, which is also undesirable. In addition, the number of seal points between adjacent links box segments will be increased, what requires an increased assembly effort and causes an increased friction during the moving of the motion part along its translational movement axis. This increase in friction must be compensated by appropriate dimensioning of the motion drive unit.

Therefore, the task of the present invention is to design a machine tool of the aforementioned art, that the linear guide device and the movement drive unit of a translational motion device can be surely protected from external influences usually prevailing on machine tools, while at the same time, a restriction of the maximal possible axial movement path of the moving part shall be possibly prevented and a possibly simple, compact design of the moving device shall be achieved.

This problem is solved in accordance with invention by a special appropriate tool machine, where the cover panel extends in the direction of the motion axis at least beyond substantially the entire length of the linear guide device, and under normal operating conditions, it is fixed immovable relatively to the base structure, especially during an operation as directed movement of the moving part

Through the invention referred to in proposed cover panel, a telescopic extendable and retractable cover panel like in the state of the art can be omitted. With this one, even synchronization gear units can be omitted, which during a motion drive unit of the motion device determine the relative motion of link box segments relatively to each other.

For non-synchronized link boxes, during the movement of the moving part, occur disturbing forces through to jerky impact of link box segments. These disturbing forces can also be prevented due to the invention. Due to the simpler design of movement devices with cover panels, according to the present invention, with lower moving mass, with otherwise the same construction, higher accelerations and higher speeds of movement parts, compared with movement device with links box covers, can be achieved.

Through the relatively high manufacturing tolerances of the links box segments, with a movement of the moving part along the movement axis, on the machine tools in the state of the art, occur different forces acting against the movement between the links box segments, which react immediately on the moving part because of the connection of the links box cover panel with the moving part. According to the invention, even this effect is prevented on the machine tool. Thus, higher positioning and machining accuracies are achievable with the machine tool, according to the invention.

The cover panel of the invention machine tool is also extended essentially along the entire length of the linear guide device, preferably even beyond axial, consistently relatively immovable to the base structure. Thus, the linear guide device of the motion device can be covered by a single cover panel and protected from external influences. This leads to the construction, compared to the state of the art, reduced in the number of required components and having less failure cases. Therefore, the cover panel and the moving part are positioned usually always on a common axial section of the moving device, regardless of the axial relative position of the moving part on the basic structure. Therefore, it is no longer necessary to connect a part of the cover panel, such as in the state of the art, for the joint movement with the moving part. However, in the state of the art, where is the moving part, it is no cover panel, and where is the cover panel, it is no moving part.

If in the present application, when describing a motion device, an axial direction is described, so this is always the direction of the movement axis of the described movement device, so in the case of the positioning device, discussed further below, the direction of the positioning axis, in the case of the shifting device, discussed further below, the direction of the shifting axis, and in the case of the vertical adjustment device, discussed further below, the direction of the vertical axis.

The cover panel can be designed, due to its relative immobility to the base structure, even with larger axial lengths of cover panel, with along the motion axis of essentially uniform component thickness, and cross-sectional shape, and cross section size. A construction room demand orthogonally to the motion axis, as is the case with the links boxes, is therefore prevented on the cover panel of the invention machine tool. The cover panel of the invention machine tool is therefore more compact than those of the state of the art and requires less construction space.

Through the omission of numerous sealing arrangements between the no longer existing link box segments, the necessary installation effort reduced for mounting of the invention machine tool will be reduced and therefore the drive forces required for the movement operation of the motion part will be reduced too.

Through the omission of elements of the cover panel connected firmly with the moving part for the common movement, a cover panel limitation of the axial maximum usable movement path of the moving part on the basic structure can be completely omitted.

With equal axial length of the basic structure and otherwise the same facilities with linear guide device and motion drive unit, even a moving part of a machine tool of the present invention relatively to the base structure can be positioned beyond a larger range of axial area than with the case of the state of the art machine tools with basic structures, where the cover panels are traditionally covered with link boxes.

Also so, for example, if the motion axis is positioning in a direction of a machine stand of the machine tool to an operator standing before the machine stand (classically this is the Y-axis direction), the basic structure for the provision of the same motion path as in the state of the art, can be made shorter and thus, the shortening of the base structure as additional stand depth can be gained, what increases the overall stability and the overall stiffness of the invention machine tool compared to the one in the state of the art.

Thus, with the same dimensions, the motion part can be moved closer to a machine operator than in the case with the state of the art. This invention increases the ergonomics of the invention machine tool, as now operating positions of the motion part are retractable, in which useful areas of the motion part for machine operators are more available than previously.

The indication on the operational definition, in particular during an intended movement operation, shall demonstrate that the cover panel, of course, can be removable for maintenance and repair of the base structure. For the use of the invention machine tool, it is only important in the technical advantages, how the cover panel it is connected with the base structure, when the machine tool is designed and prepared for the intended machining of work piece.

Because in the work piece machining, especially for the machining of the work piece, gravity-driven dirt falls on the ground, particularly translational movement devices with horizontal motion axis are protected from external influences through the design of the invention. However, general for movement devices with not only vertical movement axis direction can especially use the technical advantages developed through the present invention.

The advantages of the present invention can be more, as more the movement axis is horizontally oriented to covered motion device. Therefore, the above-discussed cover panel comes preferably in motion devices with predominantly horizontal motion axis. A motion axis is predominantly horizontal, if its positioning component per axial length is longer in the horizontal direction than in the vertical direction. Basically, the cover panel of invention machine tool can be used also for vertical motion devices with vertical movement axis.

A translational motion axis in case of doubt should apply for the present application as horizontal, if it is positioning parallel to a horizontal reference level of a machine stand of the machine tool, with regard to the machine stand which will be mounted on the machine tool. In doubt, a translational movement axis can be applied as vertical, if it is positioning orthogonally to this reference level of the machine stand.

As motion drive unit, beneficially a cost-effective spindle drive can be used. However, a linear drive unit should also not be excluded as motion drive, if just this one, compared with spindle drive, leads to significantly higher production costs of the machine tool.

Other than in the state of the art, where the motion part is placed between two cover panels and thus can be directly connected with guide carriages of the linear guide device, in the invention machine tool, at least some sections of the cover panel are arranged between an outer surface of the motion part and the linear guide device, so that the flow of forces from outside acting on the motion part, so as also machining forces, cannot be initiated straight directly in the linear guide device. It can be provided, that motion part, regardless of its position along the motion axis, encompasses the cover panel in the circumferential direction to the motion axis with the formation of the essentially orthogonal receiving gap between the motion part and cover panel at least at one of its longitudinal edges positioning in the direction of the motion axis, preferably on both longitudinal edges.

For reasons of rigidity, the motion part preferably completely encompasses the cover panel in the circumferential direction to the motion axis.

Surprisingly, it is proved that this encompassing or surrounding construction does not lead to the actually expected loss of stiffness. Through ribbing from single or multiple components of the motion part, through the encompassing or surrounding construction, feared loss of stiffness of the motion part can be largely or even completely compensated.

The motion part can have at least following two separately designed components mounted separately from each other and mounted to a motion part with each other: a guide part predominantly or preferably completely below the cover panel, so between cover panel and base structure, and a use part predominantly or preferably completely outside of the cover panel, so on the side facing away from the motion part. The guide part can be connected with the use part through at least a connection bar, preferably through two parallel connection bars. Preferably, the motion part encompasses at least two connection bars, namely at each cross at least one of them. Preferably, each connection bars can be separately mounted as a separate component of the guide part and use part.

Preferably, the guide part is directly connected with one or more mobile units of the linear guide unit. Such mobile units can be guide carriages supported by rolling units, guide carriages supporting by hydrostatic units, or gliding guide sections supported by hydrodynamic guide units. Also the use part can be used for mounting of the tool or preferably the work piece. The connection bars are preferably parallel to the motion axis of the movement device. They can also be placed towards longitudinal edge of the cover panel in the direction of the motion axis.

To reduce the number of components of the motion part, at least one connection bar can be mounted, even as one single piece, either with the guide part or with the use part. However, this requires high production costs. It can be also thought to mount at least one connection bar as two partial connection bars, of which the one single piece can be mounted with the use part and the other single piece can be mounted with the guide part.

To be able to protect the linear guide device and the motion drive unit, if possible, from several sides, against external influences, according to a favorable development of the present invention, it can be provided, that the cover panel encompasses a top thigh section spanning the linear guide device and at least one of these edge thigh sections protruding to the basic structure in an orthogonal process direction to the motion axis with the process component, wherein the edge thigh section at his end being distant from the top thigh section has a free longitudinal edge stretching in the direction of the motion axis. Especially preferably, the cover panel encompasses two edge thigh sections protruding in an orthogonal process direction with the process component to the base structure with preferably ever free longitudinal edge, wherein then the top thigh section is provided between the edge thigh sections. Preferably, each edge thigh sections have a process direction parallel to the motion axis and a further process direction to the base structure. The material thickness direction is orthogonal to both of these process directions.

According to a beneficial further design, the linear guide device can be construed of several, particularly two, partial guide devices, where each of them has a guide carriage which is guided in the guide rail longitudinal direction. The linear guide rails of the individual part guide devices are parallel to each other.

In the presence of several, in particular two partial guide devices, the motion drive unit is preferably located between two partial guide devices. The cover panel, in particular the aforementioned top thigh section, as was stated above, preferably cover the entire linear guide device, so a majority of partial guide devices, preferably all the partial guide devices forming the linear guide device.

For motion devices with horizontal motion axis, the process component to the basic structure is a process component in the direction of gravity effect. For motion devices with vertical motion axis, the process component to the basic structure has a process component orthogonal to the direction of gravity effect.

The process component to the basic structure can be, but must not, the only process component of the process direction orthogonal to the motion axis.

Particularly preferable is the cover panel placed mirror-symmetrically towards the longitudinal center level of the motion device positioned in motion axis device. This design enables an entire symmetrical design form of the motion device; and thus even enables a possible balanced force from the motion part in the linear guide device.

To further protection of the linear guide device and the motion drive unit from external influences, on the base structure, in the direction of the motion axis and in the orthogonal direction of extension to the motion axis, an apron arrangement extended to the top thigh section can be provided. In a direction orthogonal to the motion axis, preferably also orthogonally to the direction of extension, the apron arrangement can be immediately adjacent to the edge thigh section and be arranged with a gap formed between the edge thigh section and the apron arrangement

This gap essentially extends over the entire axial length of the cover panel. The gap is established locally from a section of the moving part, from a section of the guide part, whereby it is possible, to connect, other than the cover panel, situated sections of the moving part, some from the useful part, with the linear guide device covered with the cover panel. The gap thus forms a positioning gap for the moving part.

To prevent dirt from penetrating through the gap of the linear guide device and for moving drive, preferably, the apron arrangement and the immediate adjacent edge thigh portion overlap in the mentioned spanning device for orthogonally to the movement axis. Preferably, a free running in the movement axis direction longitudinal edge of the apron arrangement lies in the deck thigh portion closer than a free longitudinal edge of the apron arrangement directly adjacent the edge thigh portion. A type of simple labyrinth seal is realised on the gap in this way.

As stated above, a cover is preferred with two edge thigh portions and with one in between this deck thigh portion. In this case, it can be thought while making the machine tool according to invention that on the base structure to each edge thigh portion in a direction orthogonal to the axis of motion, immediately adjacent each, extending in the direction of the movement axis and in a direction orthogonal to the movement axis with a component to deck thigh portion toward apron arrangement is provided which is arranged in a direction orthogonal to the axis of movement with a formed between the apron arrangement and the respective immediately adjacent edge thigh portion gap, both column penetrated by a respective motion section and are covered by the deck thigh portion, wherein each apron arrangement and the immediately adjacent edge thigh portion overlap in the direction orthogonal to the movement axis extending direction.

Thus, so that parallel gaps, as a rule, are established from a moving part section, precisely a guide part, the moving part can be built with still greater stiffness. Preferably, the dimension of the edge thigh portion in the direction of the movement axis for save weight is substantially greater, for example at least eight-fold, preferably at least ten times, most preferably at least about 15-fold, than in a direction orthogonal to the material thickness direction of the edge thigh portion and to the movement axis width direction. The width direction is the above mentioned spanning direction. Also preferred for weight reductions, the dimensions of the edge thigh portion in the width direction are substantially greater, for example, at least eight-fold, -preferably at least ten-fold, most preferably at least about 15 times, as in the direction orthogonal to the width direction and the axis of movement material thickness direction of the edge thigh portion. It is the same preferred dimension relation for apron arrangement like the above for edge thigh portion.

Preferably, an apron arrangement and its directly adjacent edge thigh sections should be arranged parallel to one another. This facilitates sealing of the resulting gaps between edge thigh section, apron section and those between moving part sections significantly.

It can be seen for the fixing of the cover panel on the base structure that the cover panel is connected only along its axial longitudinal end with the base structure. In this case, the cover panel is provided floating over the area in between the axial longitudes at the base structure.

In particular, in case of big axial distances between the axial longitudes of the cover panel connected with the base structure, stiffness increasing measure can be favorable, which ensure that the cover panel always has the same shape along the axis of motion and position with respect to the base structure. For this purpose, it can be concrete that the deck thigh portion is curved about an axis parallel to the axis of movement axis and/or that the deck thigh portion is bent about an axis parallel to the movement axis. A curvature such that it is convex from the outside as viewed in the machine tool or a buckling of the deck thigh portion such that it has a convex shaped structure when viewing the machine tool from the outside, increases the probability further that externally impinging dirt particles or lubricating or cooling medium fall or run to the side of the deck thigh portion due to gravity.

Also, it is intended to avoid deflection of the cover panel about an orthogonal curved axis horizontal to the movement axis of bending according to a development of the existing invention, the cover panel on a portion of the moving member facing towards the inside to the base structure. Preferably the cover panel can be supported on the above mentioned guide part of the moving part, which is covered by the cover panel. For this purpose, the guide part or in general, the cover panel supporting moving part section can be provided with the inside of the cover to slide adjacent and/or rolling on supporting elements. For example, at the supporting moving part section a gliding supporting element can be provided on the inside of the cover panel, made from self-lubricating plastic, such Polytetrafluorethylene, or from a plastics material with graphite content. Alternatively, or additionally, the supporting element of the moving part may comprise at least one supporting rolling element, such as a support wheel, preferably many supporting rolling elements, such as supporting wheels or supporting rollers which roll upon an axial movement of the moving part on the inside of the cover.

Preferably, many supporting rolling elements are combined to form a support arrangement with rolling axes orthogonal to the movement axis, which are preferably arranged in a direction orthogonal to the moving axis common plane. Such support arrangement may be formed on axial small space with great supporting effect. Preferably, a supporting element of the above mentioned kind is provided at each longitudinal end of the supporting member movement portion, in particular of the guide part.

According to an advantageous development of the invention, it can be seen that at least one component which is built over the entire length of the cover of a the linear guide device is designed on the pioneering outer side of the cover panel,—preferably the cover as a whole.

The proposed tool of the Invention allows designing the cover according to a beneficial development of the invention completely as one piece or at least allows forming an outer shell of the entire cover forming shells of the cover panel integrally. Thus, a joint-free, over its entire axial length, significantly smooth outer shell of the cover panel can be achieved. This moves on the side facing away from the base structure outside of the cover in the axial direction gliding on the cover panel sealing structures and Increases their service life. The same applies for a joint-free inner side of the cover panel and the resulting protection of the above-mentioned support element.

Naturally, it should not be ruled out that the cover is formed in accordance with an improvement of the invention, of several parts of several separate cover panel components to form a joint gap between two axially immediately adjacent cover parts. Preferably, the joining gap is in a moving axis orthogonal plane. Here too, a protection of in the axial direction on the outer shell of the cover gliding moving sealing structures can be provided, between a direction away from the base structure outside of the cover and the moving part regardless of the position of the moving part along the movement axis, an orthogonal to the movement axis substantially receiving gap is formed, which is bridged by two axes of motion in the direction apart from each other on the sealing structures arranged on moving part, which stays gliding on the outer surface of the cover. Here, the axial spacing of the sealing structures is preferably larger than the intended maximum axial movement of the moving part relative to the base structure, so that even with use of the intended maximum axial movement path, is an axial dead zone of the cover panel, which is run over by no sealing structure. Then, a joining gap is preferably at least arranged in the axial dead zone.

This holds in the immediately preceding paragraph for arranging a joint gap on the outside of the cover with respect to two sealing structures arranged axially spaced mutatis mutandis according to the beneficial arrangement of an undertaking on the inside of the cover panel joining gap in relation to the above, preferably an axial distance from each other arranged support means for supporting the cover to a portion of the moving—part, in particular on the guide part.

Basically, the moving part can carry the tool or work piece. For example, the moving part can have a spindle tool. However, since often the tool spindle is provided on a vertical adjustment device having a vertical adjustment axis (commonly referred to as Z axis), it is preferred for the present invention that the moving part is formed on its utilization side facing away from the base structure for receiving a work piece such as a jig or/and has many T-slots.

Machine tools must have the widest possible machining of a work piece in one clamping usually over more than one translational motion axis. Therefore, it is in this case favorable if the herein discussed machine tool comprises a translational positioning device for displacement as a first moving device, of the tool and work piece relative to one another along a positioning axis as a first movement axis, wherein positioning a device support structure as a first basic structure, along the positioning axis to the support structure movable positioning device having relatively as a first moving part, a move along the positioning axis extending and positioning part leading to traverse first linear guide device and the positioning part to traverse positioning drive as a first movement drive, the first linear guide device and the positioning drive are protected against external influences by covers by a separately formed from positioning part first cover panel, which in the direction of the travel axis at least, extends over the entire length of the first linear guide device and operationally, particularly during an intended—moving operation of the positioning part, relative to the support structure immovably, is fixed. Further, the machine tool can in addition to the translational positioning device as a second movement device present a translational displacement device for displacement of the tool and work piece relative to each other along a movement axis—comprise as a second axis of movement, the direction of which is different from that of the positioning axis, wherein the displacement device comprises a supporting structure as a second base structure, one along the positioning axis movable relative to the support structure displacement part comprises as a second moving member, extending longitudinally to the displacement axis and the displacement part leading to the displacement movement of the second linear guide device, wherein the mentioned displacement part for displacing motion driving displacement drive as a second movement drive, wherein the second linear guide device and the displacement drive are covered to protect against external influences by a separately formed part of second cover, which extends in the direction of the displacement axis at least over the entire length of the second linear guide device and operationally, particularly during an intended displacement operation of the positioning part, fixed immobile relative to the support structure.

In order to achieve a highly compact space-saving design of the tool of the invention, it can further be provided that the supporting structure of the traversing is part of the positioning part of the displacement device.

Thus, traversing along the movement axis can be displaced. Thus, positioning along the positioning axis can be displaced.

Preferably positioning device and shifting device, for space-saving mobility of positioning parts in two linearly independent, preferably non-vertical, more preferably horizontal spatial directions, form a cross table arrangement with preferably mutually orthogonal axes of motion.

To provide a machine tool according to the invention with the highest possible rigidity, it is preferred if the support structure part is a machine stand of the machine tool. The support structure may be a separate component mounted on machine stand, but for reasons beyond rigidity by preference an integral part of a preferably one-piece machine bed of the machine tool.

As an additional manipulation device, the machine tool can be a translational vertical adjustment as one, possibly more, moving device having to adjust from the tool and work piece relative to one another along a mainly vertical, more preferable vertical, vertical axis as one, optionally, moving axis, with the vertical adjustment device as a basic structure, optionally further, base structure, along the vertical axis movable relative to the basic structure adjustment part as one, optionally further, moving part extending along the vertical axis and the adjustment for adjusting leading guide device as one, optionally further linear guide device and the adjustment part for adjustment movement driving adjustment drive as one, optionally further comprising motion drive, the guide device and the adjustment for protection against external influences are covered by a separately formed adjusting vertical coverage as one, optionally, other cover.

Alternatively, for the formation according to the Invention, the cover of the vertical—movement device may be designed as a conventional length-variable cover which is immovably fixed at one end for common movement with the adjusting part and the other end relative to the base structure of these, such as link box, bellows and the like.

The cover panel of a machine tool according to the invention is in contrast to link boxes or bellows invariable in length and has the proper operation of the machine tool and always the same constant dimensions.

Preferably, the adjustment of the vertical adjustment device carries a drive spindle for rotating a cutting tool. However, this need not be so.

Furthermore, the machine tool may additionally comprise the translational movement axes and the above-mentioned one or two rotational axes of movement.

It may also be thought with respect to deviation of the above description that two or even three translational moving devices having mutually linearly independent axes of motion, carry a tool holder, such as a drive spindle, and that a work piece holder is carried exclusively by one or two rotary motion devices with preferably linearly independent axes of rotation.

The present invention will be described below with reference to the accompanying drawings. It shows:

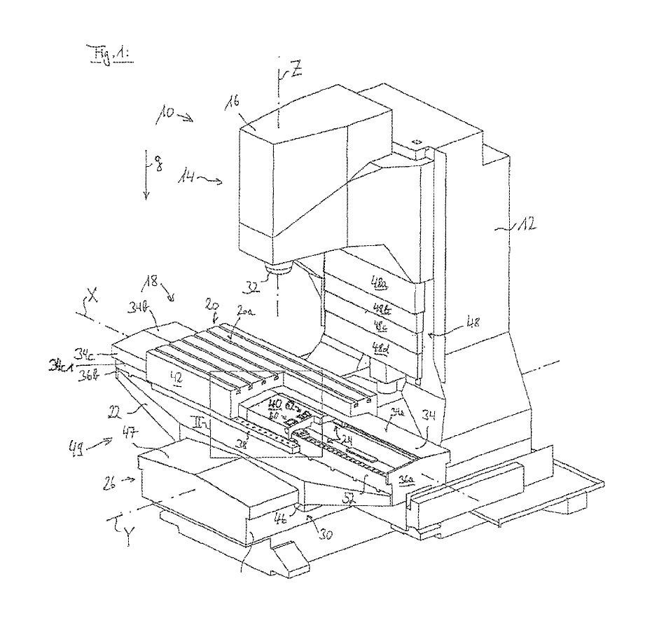

FIG. 1 is a perspective view of an embodiment of a machine tool according to the—invention in partial section,

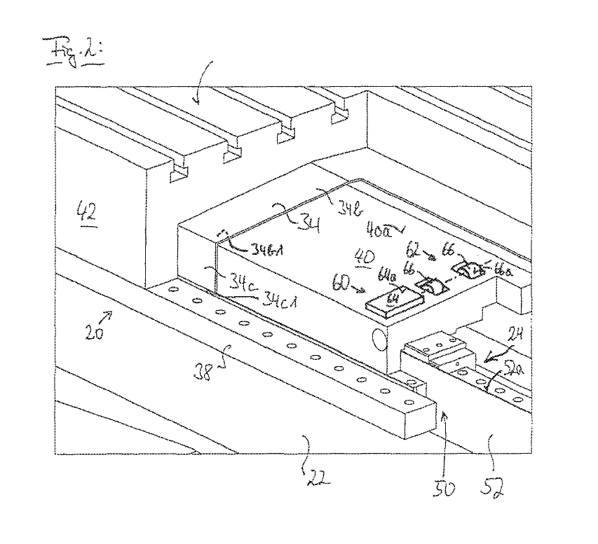

FIG. 2 is denoted by II image section of FIG. 1,

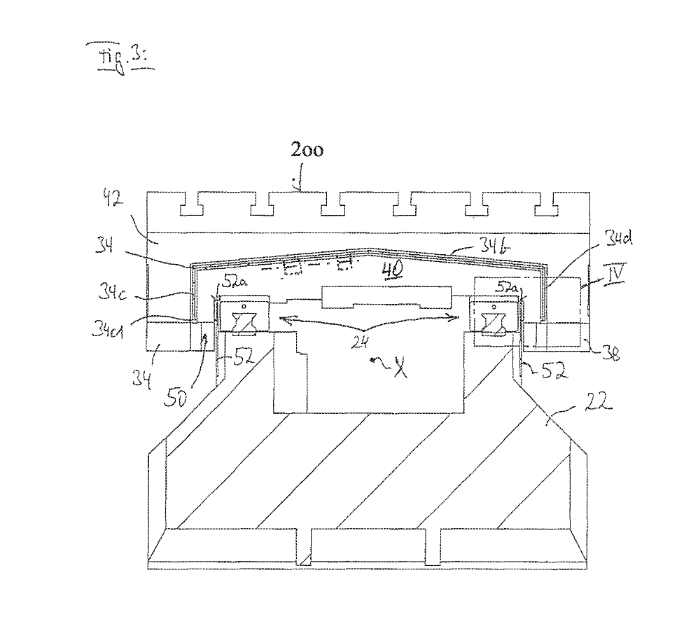

FIG. 3 is a sectional view through the positioning device of the machine tool of FIG. 1 when viewed orthogonal to the travel axis of a cutting plane,

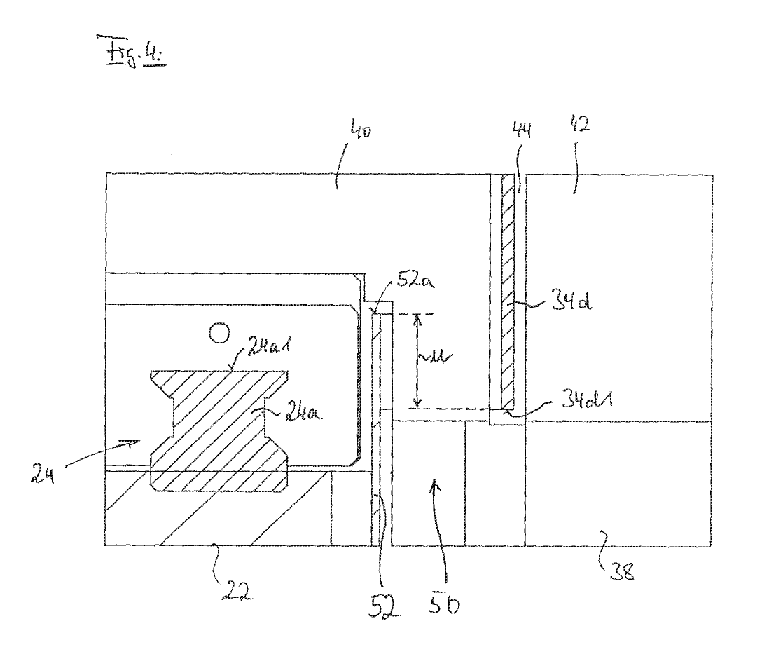

FIG. 4 designated with IV Detail section in FIG. 3 and

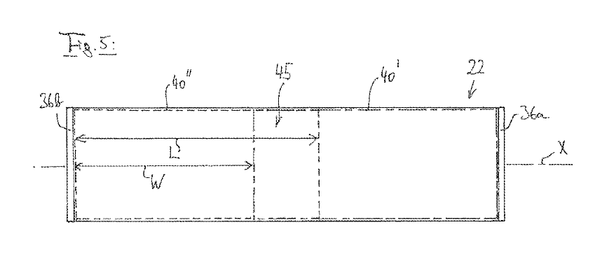

FIG. 5 is a very schematic consideration of the positioning travel of the positioning part along the positioning axis and the axial distance of the sealing structures of positioning part showing a normal condition Operation of sealing structures of positioning parts not run over dead zone of coverage of the cover panel.

In FIG. 1, an embodiment of a machine tool according to the invention is generally designated 10. As the machine tool is usually a Universal drilling-milling machine with three translational axes, namely a horizontal positioning axis X as a first axis of movement, a horizontal positioning axis Y as a second motion axis and a vertical axis Z as a further manipulation axis.

The axis designations are given according to the usual naming conventions for machine tools.

The machine tool 10 includes as a basic component a machine stand 12 to which a vertical adjustment 14 with an adjustment part 16 as well as a translational movement device 18 as a first moving device with an adjustable in the direction of the movement axis X positioning part 20 as a first moving part, a support structure 22 as a first base structure, a first linear guide 24, provided on the supporting structure and a positioning drive for clarity, not shown, such as a spindle drive, as a first movement drive are provided.

Next, the machine tool 10 comprises a horizontal displacing device 26 as a second movement device with a support structure 28 and a second base structure and a relative to the support structure 28 along the movement axis Y movable displacement part 30 as a second moving part.

The positioning part 20 is movable relative to the support structure 22 along the positioning axis X.

The positioning device 26 has to drive the positioning part 30 relative to the support structure 28 includes a shift actuator, not shown, on as a second motion drive. This can be a spindle drive like the positioning drive of the positioning part 18.

The vertical adjustment device 14 carries in the example shown a work spindle 32, which can receive a tool having one or more cuttings and set them in motion. The tool may be, for example, a drill, a milling cutter or a grinding tool.

The not shown work piece, which is to be processed is preferably set on the utilization side 20a of positioning part 20, which is shown in the illustrated example for receiving and fixing of the work piece with a known T-slot structure. At this T-slot structure, can in a defined manner, a tensioning device which is not shown be fixed, which in turn spans the work piece to be machined.

To protect the first linear guide device 24 and the positioning drive of the positioning part 18, this has a first cover panel 34, which preferably extends over the entire axial length of the positioning part 18 and the first linear guide device 24 and the positioning drive in the axial direction and transversely spanned till the roof (see also FIG. 3).

Preferably, this first cover 34 is integrally formed, for example, from splayed sheet such that the bending axes are preferably parallel to the positioning axis X. The repeated bending of the first cover 34 around the mentioned bending axes can significantly increase the flexural strength with respect to a gravity-induced bending, about an axis parallel to the movement axis Y axis.

The preferred one-piece design of the first cover 34, in particular by the integral formation of the side facing away from the support structure 22 outside 34a of the first cover 34 has a smooth, joint-free surface of the outer side 34a of the first cover 34 can be provided.

The first cover 34 advantageously has a first linear guide device 24 orthogonal to the positioning axis X, in particular parallel to the positioning axis Y spanning the present example deck thigh portion 34b and—two of this on both transverse ends of the support structure 22: in gravity direction g, parallel to the vertical axis Z, projecting edge thigh sections 34c and 34d (see FIG. 3). The deck thigh portion 34b is generally as mentioned above, preferably simply bent to increase its flexural strength about an axis parallel to the positioning axis Y axis bending at least about an axis parallel to the positioning axis X axis. Advantageously, the bending direction of the deck thigh portion 34b is selected to be 10 in consideration of the machine tool so that externally gives the traversing axis X convex structure of the first cover panel 34. This facilitates the gravitational transport of coolant and/or lubricant that impinges on the deck thigh portion 34b of the machining site of the work piece. The same applies to 34b on the deck thigh portion impinging machining chips.

The support structure 22 has at its two longitudinal ends of a respective end plate 36a and 36b at which the longitudinal ends of the first cover 34, preferably exclusively, are fastened, by bolting, preferably with the material of the first cover 34 deep seated screw heads. A fixing portion of the fixing plates 36a and 36b is formed in its contour of the inner contour of the first cover panel 34. In the example shown, the attachment plates 36a and 36b are roughly T-shaped, so that the mounting portion of the mounting plates 36a can laterally reach to the edge of the thigh portions 34c and 34d of the first cover panel 34. Below the fastening portion, i.e. in the completely mounted state of the first cover 34 provided portion of the fastening plates 36a, however, is orthogonal preferably formed in the width direction of the support structure 22 to the positioning axis X with a smaller width so that it can pass axially from the longitudinal ends of connecting strips 38 of the fastener part 20. Thereby, the axial position positioning part 20 increases relative to the support structure 22.

The positioning part 20 has favorably at least three parts, more preferably constructed at least with four-pieces. It comprises, in the illustrated example, two mentioned connection bars 38, which is covered with one of the first cover panel 34 and directly coupled with the first linear guide device 24.

Guide part 40 connected to above and outside of the first cover panel 34 arranged product piece 42, which serves as the actual recording of a work piece shown in the example. Between the mentioned guide member parts 40, connecting blocks 38 and product piece 42, a receiving gap 44 is formed, in which the first cover panel 34 is arranged and along which a portion of the first cover panel 34, the moving member 20 passes through axially in the Illustrated example.

With the herein described first cover panel 34, it is possible to move positioning part 20 axially so far that the guide member 40 joins the attachment plates 36a or 36b lengthwise. Therefore, at a predetermined length of the support structure 22, there is no intolerable restriction to the axial positioning travel through a conventional cover panel, such as a link box and the like. In fact, the axial position of the positioning part 20 is determined relative to the support structure 22 substantially by the axial length of the support structure 22, in particular by the axial clearance between the mounting plates 36a and 36b and by the axial length of the guide part 40.

The product piece 42, therefore can be formed with the product side 20a containing section, preferably, reaching out in one or in both axial end positions, even beyond the respective end positions arranged at longitudinal ends of the support structure 22, so that the useful part 42 protrudes over the guide member 40 axially at least on one or preferably on both axial sides.

In the illustrated construction, the positioning part 20 surrounds the first cover panel 34 circumferentially around the positioning axis X completely.

In the Illustrated example, the first cover panel 34 is integrally formed. However, this can also be formed in many pieces, for example, in two parts.

The first cover panel 34 has a roughly schematically C-shaped cross section when viewed along an axial direction of projection, whereby this cross-section remains significantly unchanged due to the preferably one-piece construction along the traversing axis X.

If a joining gap between two cover parts is inevitable, it shall be preferentially designed so that it is located in an orthogonal level to the positioning axis X of the positioning device 18.

For the discussion of a possible advantageous arrangement of the joining gap in the first cover panel 34, it shall be referenced following upon the sketchy FIG. 5:

In FIG. 5, the bearing structure 22 with the guide part 40 of the positioning part 20 with the viewing direction of gravity effect g is roughly schematically illustrated. The guide part is illustrated in its axial (right) end position, nearest to the mounting plate 36a, dash-lined with different length of dashes, as moving part 40′. In his opposite axial (left) end position, which is located nearest to the mounting plate 36b of the bearing structure 22, the guide part 40 is illustrated with the same length of dashes as guide part 40″.

Thus, the arrow W shows axial maximal walkable area from the guide part 40 and thus the axial positioning area of the guide part 40 and/or the positioning part 20. This is the distance between the opposite axial end position and of the same component section of the moving part, also here the positioning part 20.

The aforementioned receiving gap 44 is bridged preferably with a sealing structure at least from the side of the product piece 42 on both longitudinal ends of the section of product piece placed oppositely the first cover place 34, so a sealing lip and/or a scraper to the cover panel 34, which glides, with axial movement of the positioning part 20, axial glidingly on the outer surface of the deck thigh section 34b, as well as the edge thigh sections 34c and 34d. Therefore, it is guaranteed that the gliding device intervention of the sealing structures is maintained with all intended operating conditions of the positioning part 20, so each seal structure in the area the axial positioning travel W of the positioning part 20 is actually arranged to limiting longitudinal ends of the positioning part 40. Ideally, the axial distance is equal to the dense structures not shown in the figures, which are arranged preferably in a level orthogonal to the positioning axis X, so the axial length of the guide carriage 40. This is indicated with L in FIG. 5. If now, as in the illustrated sample, the length L, as the axial distance between the sealing structures for the sealing of the receiving gap 44, is selected longer than the maximum possible axial positioning travel W, then, around to the longitudinal center of the bearing structure 22, an axial dead zone 45 is created that cannot be crossed by a sealing structure at any time of the proper operation of the machine tool 10. It is therefore preferred, to arrange the joining gaps between individual parts of the first cover panel 34, in the dead zone 45 of the first cover panel 34, so they are present, so that a crossing of the joining gap through a sealing structure and thus related significant mechanical overhead of the sealing structure will be prevented.

Furthermore, on the surface of the guide part 40 pointed to the first cover panel 34, supporting elements that are not shown in the figures may be provided to support the first cover panel 34 in direction of gravity effect g glidingly and/or shifted in device intervention with the inner surface of the first cover panel 34. In order that even these supporting elements will not cross joining gap arranged in the dead zone 45 with proper use of the tool machine 10, the supporting elements are preferably arranged to the previously discussed sealing structures lying opposite the direction of gap width towards the receiving gap 44. In other words: The axial distance between such supporting elements is essentially the same as the axial distance between the sealing structures of the positioning part 20.

The bearing structure 22 of the shifting part 30 is preferred, as a corresponding construction part of the product piece 42 of the positioning part 20 of the shifting part 30. The positioning device 18 and the shifting device 28 form thus a cross table device 49.

The shifting device 26 that is used for the shifting of the shifting part 30, and therefore prefers the bearing structure 22, in an orthogonal horizontal positioning axis Y to the positioning axis X, is maintained in the same way to the positioning device 18 described above.

In particular, on the other hand, the shifting part 30 is formed with a guide part located under its second cover panel 47, and with the guide of the shifting device 26 and the connection bars 46 that are connected with the bearing structure 22. The Support structure 28 of the shifting device 26 is preferably an integral part of the machine stand 12.

Since in this example, the vertical adjustment device 16 bearing the working spindle 32, when using the cover panel previously discussed, can lead to open gaps which are open in the direction of gravity effect and orthogonal to it, so for the basic structure of the vertical adjustment device 14, and this is in this case the machine stands 12, a conventional cover panel in form of a links box 48 is selected. Because the links box 48 is telescoping length variable and has link segments 48a to 48d moving relatively to each other, so a gap between cover panel 48 and machine stand 12 and/or general basic structure on the vertical adjustment device 14 may be prevented. However, it shall not be excluded that a cover panel is mounted on the vertical adjustment device Z, as it was previously discussed for the positioning device 18 and the shifting device 26.

On the links box 48 of the vertical adjustment device 16, the movement travel limiting effect of the links box 48 is recognized. The link segment 48a, axial nearest to the adjustment part 16, is firmly connected to it for joint motion. The link segment 48d placed at the furthest distance from the adjustment part 16 is firmly connected to the machine stand 12 immovable to it, as well. Therefore, the adjustment part 16 in direction of gravity effect g cannot be more lowered along the vertical axis Z than either the most distant adjustment part of the longitudinal end of the link segment 48a is arrived at the most distant adjustment part of the longitudinal end of the fixed machine stand link segment 48d, or the most next adjustment part of the longitudinal end of the fixed machine stand link segment 48d is arrived at the most next adjustment part of the longitudinal end of the link segment 48a.

Therefore, for adjustment of the previously discussed cover panel 34 and/or 47, according to the invention, the axial length of the fixed adjustment part of the link segment 48a or of the fixed machine stand link segment 48d may be gained as additional axial positioning travel.

To seal further the gap 50 against ingress of dirt inside of the bearing structure 22, which is opened down on the moving devices 18 and 26 with horizontal moving axis X Respectively Y, where, as in the stated example, a section of the guide part 40 moves axially, an apron arrangement 52 orthogonal to the positioning axis X on the bearing structure 22 from both sides is preferred. The apron arrangement 52 is preferably made of a flat material, so of a flat steel sheet or a flat plastic strip, which is extending, like the edge thigh sections 34c and 34d of the first cover panel 34, preferably to the top thigh section 34b, i.e. here gravity effect direction g, and to the positioning axis X. Thereby, each apron arrangement 52 is placed directly opposite to another edge thigh 34c and/or 34d orthogonally to positioning axis X. To prevent the dirt penetration between the apron arrangements 52 and the formed gaps 50 respectively associated to top thigh sections 34c and/or 34d, it is provided to overlap the apron arrangements 52 and respectively associated top thigh sections 34c and/or 34d in the direction of gravity effect g. In FIG. 4, an overlap is graphically depicted with U. Thereby, the free longitudinal edge 52a of an apron arrangement 52 located contrary to the direction of gravity effect g preferably in the direction of positioning axis X away from the free longitudinal edge 34c1 and/or 34dl of the directly opposite edge thigh section 34c and/or 34d, so closer to the top thigh section 34b than the latter. Thus, a kind of labyrinth seal can be made, which prevents the entry of dirt from the outside into the inside of the bearing structure 22, and similar in the inside of the bearing structure 28. Preferably, the free longitudinal edge 52a of the apron arrangement 52 contrary to the direction of gravity effect g is also placed with a distance from a surface 24a1 of the linear guide rail 24a of the first linear guide device 24. Thus, the risk can be reduced that dirt, that occurs oppositely the direction of the gravity effect into the gap 50 from below—so by bouncing from a different structure—will be placed on the running surface 24al1 of the guide rail 24a of the first linear guide device 24 and will damage the first linear guide device 24 or shorten its service life.

Preferably, the tool machine 10 is constructed in such a way, that its bearing structure 22 in its axial length or the support structure 28 in its axial length, including the transverse direction of the machine stand 12, i.e. from a distant machine stand mounting plate, reaching up to the rear of the machine stand 12, exploits the maximum clear width of a cargo container, so that the tool machine 10 illustrated here can be shipped favorably in conventional standard cargo containers with about 2.50 meters lights width, without that adherence to the cargo measurement will require an undesirable shortening of axial movement path of a horizontal movement device.

Returning to FIG. 1, there are illustrated supporting elements 60 and/or 62 on the guide part 40 as example.

The supporting elements 60 and/or 62 can be better recognized in FIG. 2. Thereby, only the supporting elements 60 or only the supporting elements 62 can be illustrated on the guide part 40, or, as shown, both supporting elements 60 and 62 can be jointly provided. The supporting elements 60 and/or 62 are preferably arranged on each longitudinal end of the guide part 40.

The supporting element 60 includes a supporting part 64, which is placed glidingly to the Inner side 34b1 of the top thigh section 34b of the cover panel 34 pointing to the guide part 40. To do this, the supporting part 64 can have a specially designated gliding surface 64a, which is in gliding system with the Inner surface 34b1 to support the cover panel 34, to support especially in the direction of gravity effect. The intervention of the gliding device between the supporting part 64 and the top thigh section 34b takes place independently on the axial position of the guide part 40.

The supporting element 62, in contrast to the supporting element 60, has supporting rolling element 66, which, using a rolling surface 66a, that can be a cylindrical surface, can be in rolling contact with the Inner surface 34b1 of the top thigh section 34b of the cover panel 34.

Even the supporting rolling elements 66 are independently from the axial position of the guide part in rolling contact with the Inner surface 34b1 of the top thigh section 34b. With the axial movement of the guide part 40, the supporting rolling elements 66 are rolling off on the inner surface 34b1. The supporting rolling elements 66 can roll off without slip or even with slip.

The supporting rolling elements 66 are arranged with regard to their axes of rotation preferably collinearly and/or in a common level orthogonally to the movement axis X, to require minimal axial (based on the movement axis X) space of the guide part (40) for the inclusion of the supporting rolling elements 66.

The supporting part 64 can be made of self-lubricating material, for example, of PTFE. The same applies to the supporting rolling elements 66; they also can be made from other materials, like elastomers, thermosets, metals, or of a hard, rigid rolling body core with a comparatively softer gear outer layer.

Preferably, the supporting rolling elements 66 are depressed in the guide part 40 and protrude above only with a part of their body over a surface of the guide part 40a to the Inner side 34b1 of the top thigh section 34b.

Through the supporting elements 60 and/or 62, the cover panel 34 may be supported against gravity effect, or against the effects of machining forces between their long-transmission side mounting positions, which can prevent an undesired deflection of the cover panel.

As the supporting elements 60 and/or 62 are preferably provided at the longitudinal ends of the guide part 40, where are also the above mentioned seal structures, so the above benefits apply on the situation of joining gaps for the supporting elements 60 and 62, as well.

1-15. (canceled)

16. Tooling machine (10), preferably for the machining of a workpiece by a tool, with at least one translational movement device (18, 26) for displacing the tool and the workpiece in relation to each other along a movement axis (X, Y), said movement device (18, 26) comprising a basic structure (22, 28), a movement portion (20, 30) which can be displaced along said movement axis (X, Y) in relation to the basic structure (22, 28), a linear guiding device (24) extending along said movement axis (X, Y) and guiding the movement portion (20, 30) for movement and a motion drive driving said movement portion (20, 30) for movement, wherein said linear guiding device (24) and said motion drive are covered by a cover (34, 47) which is formed separately from the movement portion (20, 30) to protect the latter against exterior influences, such as chippings or/and splashes of lubricant or/and splashes of cooling agent, wherein said cover (34, 47) extends in the direction of said movement axis (X, Y) at least across substantially the entire length of said linear guiding device (24) and is in terms of operation, in particular during movement operation of the movement portion (20, 30) according to its intended use, rigidly fixed in relation to the basic structure (22, 28),
wherein an inner side (34b1) of said cover (34), facing towards the basic structure (22, 28), is supported at a section of said movement portion (20, 30).

17. Tooling machine (10) according to claim 16,
wherein said movement portion (20, 30) comprises a guiding portion (40) which is preferably completely entirely provided below the cover (34), wherein the cover (34) is supported at the guiding portion (40) of said movement portion (20, 30).

18. Tooling machine (10) according to claim 16,
wherein a portion of said movement portion (20, 30) supporting said cover (34), in particular said guiding portion (40), is provided with support means (60, 62) abutting slidingly or/and shiftingly at the inner side (34b1) of the cover (34), wherein, in particular at the portion of said movement portion (20, 30) supporting said cover (34), a support portion (64) abutting slidingly at the inner side (34b1) of the cover (34) is provided, which is especially made of self-lubricating plastics, such as polytetrafluorethylene or of a plastics with graphite contents.

19. Tooling machine (10) according to claim 17,
wherein said support means (60, 62) of said movement portion (20, 30) comprise at least one support rolling element (66), for example a support wheel, preferably a plurality of support rolling elements (66), such as for example support wheels or support rollers, which during an axial movement of said movement portion (20, 30) roll at the inner side (34b1) of the cover, wherein in particular a plurality of support rolling elements (66) is combined in a support arrangement (62) with rolling axes which are orthogonal to the movement axis (X), said rolling axes of the single support rolling elements being preferably arranged in a common plane orthogonal to the movement axis (X).

20. Tooling machine (10) according to claim 17,
Wherein one support means (60, 62) being provided at each longitudinal end of said portion of the movement portion (20, 30) supporting the cover (34), in particular of the guiding portion (40).

21. Tooling machine according to claim 16,
wherein said movement portion (20, 30) embraces the cover (34, 47), independently of its position along said movement axis (X, Y), in the circumferential direction about said movement axis (X, Y) forming a receiving gap (44) between said movement portion (20, 30) and the cover (34, 47) which is substantially orthogonal to said movement axis (X, Y), in at least one of its longitudinal edges (34c1, 34d1) extending in the direction of said movement axis (X, Y), preferably at both longitudinal edges (34c1, 34dl), and preferably surrounds said cover (34, 47) entirely.

22. Tooling machine (10) according to claim 16,
wherein said cover (34, 47) comprise a cover leg portion (34b) spanning said linear guiding device (24) and at least one border leg portion (34c, 34d) projecting with a direction component towards the basic structure (22, 28), said border leg portion (34c, 34d) comprising at its end opposite the cover leg portion (34b) a free longitudinal border (34c1, 34d1) extending towards said movement axis (X, Y), said cover (34, 47) comprising with particular preference two border leg portions (34c, 34d) projecting with a direction component towards the basic structure (22, 28), said cover leg portion (34b) being provided between said border leg portions (34c, 34d), wherein, in particular at the basic structure (22, 28), a skirting arrangement (52) is provided, extending towards said movement axis (X, Y) and with a component towards said cover leg portion (34b), directly adjacent to a border leg portion (34c, 34d) in a direction orthogonal to said movement axis (X, Y) and with a gap (50) formed between said border leg portion (34c, 34d) and the skirting arrangement (52), through which a movement portion section passes and which is covered by said cover leg portion (34b), said skirting arrangement (52) and the border leg portion (34c, 34d) arranged immediately next to it overlapping in a direction (u) orthogonal to the movement axis, wherein in particular said cover (34, 47) comprises two border leg portions (34c, 34d) with a cover leg portion (34b) arranged in between, and wherein a skirting arrangement (52) is provided at the basic structure (22, 28) directly adjacent to each border leg portion (34c, 34d) in a direction orthogonal to said movement axis (X, Y), extending in a direction of the movement axis (X, Y) and with a component towards said cover leg portion (34b), the latter being arranged in a direction orthogonal to said movement axis (X, Y) with a gap (50) formed between said skirting arrangement (52) and the directly adjacent border leg portion (34c, 34d), with a movement portion section passing through both gaps (50) and said cover leg portion (34b) covering them, with each skirting arrangement (52) and the directly adjacent border leg portion (34c, 34d) overlapping in a direction (X, Y) orthogonal to said movement axis.

23. Tooling machine (10) according to claim 22,
wherein said cover leg portion (34b) is curved about an axis of curvature parallel to said movement axis (X, Y), preferably convex-shaped when said tooling machine (10) is seen from the outside, or/and that said cover leg portion (34b) is bent about a bending axis parallel to said movement axis (X, Y), preferably forming a convex structure when said tooling machine (10) is seen from the outside.

24. Tooling machine (10) according to claim 16,
wherein said cover (34, 47) is connected to the basic structure (22, 28) only in its axial longitudinal end sections.

25. Tooling machine (10) according to claim 16,
wherein at least one component forming, over the entire length of said cover (34, 47), an outer side (34a) of the cover (34, 47) extending away from the linear guiding device (24), preferably the entire cover (34, 47), is designed in one piece.

26. Tooling machine (10) according to claim 16,
wherein said cover (34, 47) consists of many parts, i.e. of several separated cover components forming at least one joining gap between two adjacent cover components, preferably in a plane which is orthogonal to said movement axis (X, Y), wherein in particular between an outer side (34a) of the cover (34) facing away from the basic structure (22, 28) and said movement portion (20, 30) independent of the position of said movement portion (20, 30) along said movement axis (X, Y), a receiving gap (44) is formed substantially orthogonal to said movement axis (X, Y) and it is bridged by two sealing structures arranged at said movement portion (20, 30) with a distance (L) in the movement direction, the latter abutting in a displaceable manner at the outer side (34a) of the cover (34, 47) wherein preferably the axial distance (L) of the sealing structures is bigger than the defined maximum axial movement path (W) of said movement portion (20, 30) in relation to said basic structure (22, 28) so that even when the defined maximum axial movement path (W) is used, an axial dead zone (45) of the cover (34, 47) will occur, which cannot be bridged by a sealing structure, wherein the at least one joining gap is arranged in the axial dead zone (45).

27. Tooling machine (10) according to claim 16,
wherein said movement portion (20, 30) is adapted on its usable side (20a) opposite the basic structure (22, 28) for receiving a workpiece, for example a clamping device or/and a plurality of T-grooves.

28. Tooling machine (10) according to claim 16,
wherein as a first movement device (18, 26) it comprises a translational positioning device (18) for displacing the tool and the workpiece in relation to each other along a positioning axis (X) as a first movement axis (X, Y), said positioning device (18) comprising a support structure (22) as a first basic structure (22, 28), a positioning portion (20) moveable along said positioning axis (X) in relation to the support structure (22) as a first movement portion (20, 30), a first linear guiding device (24) extending along said positioning axis (X) and guiding the positioning portion (20) for its positioning movement, and a positioning drive driving said positioning portion (20) for a positioning movement as a first movement drive, said first linear guiding device (24) and said positioning drive being covered by a cover (34) which is formed separately from the positioning portion (20) to protect the latter against exterior influences, the cover extending in the direction of said positioning axis (X), at least over approximately the entire length of said first linear guiding device (24) and which is operatively rigidly fixed at the support structure (22), in particular during a defined positioning operation of said positioning portion (20), and in that it comprises additionally to the translational positioning device (18) a translational displacement device (26) as a second movement device (18, 26) for displacing tool and workpiece in relation to each other along a displacement axis (Y) as a second movement axis (X,Y) whose direction is different from said positioning axis (X), wherein said displacement device (26) comprises a support structure (28) as a second basic structure (22, 28), a displacement portion (30) which can be moved along said displacement axis (Y) in relation to the support structure (28) as a second movement portion (20, 30), a second linear guiding device extending along said displacement axis (Y) and guiding said displacement portion (30) for a displacement movement, and a displacement drive as a second movement drive, driving said displacement portion (30) for a displacement movement, said second linear guiding device and said displacement drive being covered by a cover (47) which is formed separately from the displacement portion (30) to protect the latter against exterior influences, the cover extending in the direction of said displacement axis (Y) at least over the entire length of said second linear guiding device and which is operatively rigidly fixed at the support structure (28), in particular during a defined displacement operation of said displacement portion (30), wherein especially said support structure (22) of said positioning device (18) is part of said displacement portion (30) of said displacement device (26), wherein positioning device (18) and displacement device (26) preferably form a cross table device (49).

29. Tooling machine (10) according claim 16,
wherein the basic structure (22, 28), in particular the support structure (28) is a mounted or integral part of a machine base (12) of the tooling machine (10).

30. Tooling machine (10) according to claim 16,
wherein it comprises a translational vertical adjustment device (14) possibly as a further movement device for adjusting tool and workpiece in relation to each other along a substantially vertical, particularly preferred a vertical axis (Z), possibly as a further movement axis, said vertical adjustment device (14) comprising a general structure (12), possibly as a further basic structure, an adjustment portion (16) moveable along said vertical axis (Z) in relation to the general structure (12), possibly as a further movement portion, a guiding device extending along said vertical axis (Z) and guiding the adjustment portion (16) for its adjusting movement, possibly as a further linear guiding device, and an adjustment drive driving said adjustment portion (16) for its adjusting movement, possibly as a further movement drive, said guiding device and said adjustment drive being covered by a vertical cover (48), which is formed separately from the adjustment portion (16), possibly as a further cover, to protect against exterior influences.
